(19) United States
(12) Patent Application Publication
(10) Pub. No.: US 2006/0144257 A1
(43) Pub. Date: Jul. 6, 2006

(54) Methods and apparatus for a vegetable spinner

(76) Inventors: Larry Cheng, Palo Alto, CA (US); Jesse Fourt, Menlo Park, CA (US); Branko Lukic, Menlo Park, CA (US); Annetta Papadopoulos, Palo Alto, CA (US); Thomas Overthun, San Francisco, CA (US); James R. Yurchenco, Palo Alto, CA (US); Sean Corcorran, Palo Alto, CA (US)

Correspondence Address: Snell & Wilmer L.L.P.;One Arizona Center, 400 East Van Buren, Phoenix, AZ, 85004-2202, US

(21) Appl. No.: 10/845,997

(22) Filed: May 14, 2004

Related U.S. Application Data
(60) Provisional application No. 60/471,417, filed on May 16, 2003.

(51) Int. Cl. B26D 1/00

(52) U.S. Cl. 99/511

(57) ABSTRACT

A vegetable drying device is configured to remove excess moisture from suitably-sized vegetables through a spinning action. The device generally includes an outer bowl, an inner basket, a lid, and a cover assembly, wherein the cover assembly includes a pull-handle and a brake mechanism. The user grasps the handle and pulls outward, thus providing rotational energy, through a suitable mechanical coupling, to the inner basket and lid. The pull handle and attached cord are preferably retractable.

### CROSS REFERENCE TO RELATED APPLICATIONS

This application claims priority of U.S. Provisional Patent Application No. 60/471,417, filed May 16, 2003 and is incorporated herein by reference.

### FIELD OF THE INVENTION

The present invention generally relates to food preparation devices and, more particularly, to a spinner device configured to spin-dry salads, vegetables, and other such food items.

### BACKGROUND OF THE INVENTION

It is often desirable, when preparing lettuce, vegetable, and the like, to rinse these food items to remove unwanted dirt, chemicals, or other debris. In doing so, however, the excess moisture that remains on the food items can be undesirable from a culinary perspective. This is particularly the case with lettuce and other salad greens, which tend to retain moisture, and are thus difficult to coat with oil-based dressings.

To solve this problem, many manufacturers have developed vegetable drying devices, or “salad spinners.” Most of these drying devices use a rotating basket that removes moisture through centrifugal force. Rotation of the basket is generally accomplished through electrical or mechanical means. Such prior art devices are unsatisfactory in a number of respects.

For example, many mechanical drying devices use a crank. Such cranks tend to be slippery and restrain the user to movement within a single plane (i.e., the plane defined by the clank). It is thus difficult and tiresome to grasp and move the crank repeatedly.

Other mechanical drying devices include a pull handle attached to the device via a cord. The basket in such devices is generally coupled to the cord directly such that the basket rotates one direction when the cord is first pulled and then, after the cord winds onto a spindle and the handle is retracted, the basket stops and reverses in a second direction when the handle is pulled again. These reversals of direction are inefficient, and result in a tiresomely repetitive process for the user.

Furthermore, known drying devices either do not include a suitable braking mechanism (to slow down and stop the rotating basket), or include brakeing mechanisms that are inefficient and subject to early wear-out.

Furthermore, known drying devices, because of their awkwardly-placed drive mechanisms, cranks, and the like, do not typically have a flat top surface. As a result, it is impossible (and/or unsafe) to stack other kitchen items (bowls, containers, etc.) on top of such devices. This is a major drawback where kitchen-space is a premium.

Accordingly, there is a need for drying devices which overcome these and other limitation of the prior art.

### SUMMARY OF THE INVENTION

In general, the present invention provides a novel vegetable drying device configured to remove excess moisture from suitably-sized vegetables through a spinning action. In accordance with one embodiment of the present invention, the device generally includes an outer bowl, an inner basket, a lid, and a cover assembly, wherein the cover assembly includes a pull-handle and a brake mechanism. The user grasps the handle and pulls outward, thus providing rotational energy, through a suitable mechanical coupling, to the inner basket and lid. The pull handle and attached cord are preferably retractable.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 is a cross-sectional overview of a food dryer in accordance with one embodiment of the present invention;

FIG. 2 is an overview of a drive mechanism in accordance with one embodiment of the present invention;

FIGS. 3A and 3B are schematic top-views illustrating operation of the drive mechanism shown in FIG. 2;

FIG. 4 is an overview of a brake mechanism in accordance with one embodiment of the present invention;

FIG. 5 is an overview of a drive mechanism in accordance with an alternate embodiment of the present invention;

FIG. 6 is an exploded view of the drive mechanism shown in FIG. 5;

FIG. 7 is a top view illustration of a food dryer in accordance with one embodiment of the present invention;

FIG. 8 is a side view illustration of the food dryer of FIG. 7; and

FIG. 9 is an overview of an alternative sprag design.

### DETAILED DESCRIPTION

The following description is of exemplary embodiments of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention.

For example, while the present invention is often described in the context of spin-drying salad components such as lettuce and the like, it will be appreciated that the invention is not so limited, and that the methods and devices described herein may be used in connection with the drying of any suitably-sized fruit, vegetable, or any other food item.

In general, the present invention provides a novel vegetable drying device configured to remove excess moisture from suitably-sized food items through a spinning action. In accordance with one embodiment of the present invention, and as shown in the attached figures, the device generally includes an outer bowl, an inner basket, a lid, and a cover assembly, wherein the cover assembly includes a pull-handle and a brake mechanism. The user grasps the handle and pulls outward, thus providing rotational energy, through a suitable drive mechanism, to the inner basket and lid.

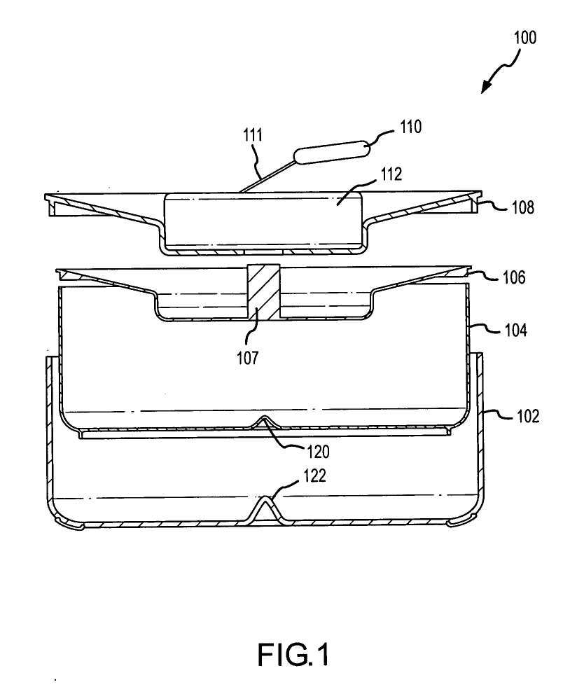

Referring to FIG. 1, a drying device 100 in accordance with one embodiment of the present invention comprises an inner basket (or “basket”) 104 having a lid 106 and configured to fit within an outer bowl (or “bowl”) 102. A cover assembly 108 is removeably coupled to lid 106, e.g., via a protrusion extending from lid 106. Cover assembly 108 includes a drive mechanism 112 (described in further detail below) coupled to a pull handle (or “handle”) 110 and attached cord 111.

Lid 106 is removeably attached to basket 104 (e.g., through a compressive fit, where the outer lip of lid 106 fits around the outer diameter of basket 104) such that both lid 106 and basket 104 may rotate with respect to bowl 102. In the illustrated embodiment, a generally conical shaped protrusion 122 extends from the center of the bottom of bowl 102, and a corresponding indentation 120 is provided in basket 104 such that basket 104 may rotate within bowl 102 with relative freedom when indentation 120 seats on protrusion 122. Basket 104 is configured to allow water to escape, e.g., through a plurality of perforations, vents, or the like.

In general, the food item to be dried is placed within basket 104, and lid 106 (which is generally rotateably fixed to a drive and brake apparatus within cover 108) is placed on basket 104. The user then pulls handle 110 such that drive mechanism 112 is activated (via cord 111), which then causes rotation of basket 104 with respect to bowl 102. Liquid attached to the food item is propelled by centrifugal force radially outward to collect within bowl 102. The user may repeatedly pull handle 110 until the food item is sufficiently dry.

It will be appreciated that handle 110 may have a variety of shapes, and is thus not limited by the embodiment shown in the drawings. Similarly, it will be appreciated that the various components may be manufactured using any suitable material, including various plastics, ceramics, metals, and glasses.

In one embodiment, for example, outer bowl 102 is a transparent or translucent plastic. Similarly, portions of cover assembly 108 and lid 106 may be transparent or translucent plastic to facilitate viewing of the food item during processing. Bowl 102 (and basket 104) may have any convenient diameter and height, and is not limited by the scale of the attached drawings.

In the preferred embodiment, drive mechanism 112 is configured such that rotational energy is generated when handle 110 is pulled outward, but wherein basket 104 rotates freely when the cord is stationary or is in a retracting (or retracted) state. That is, the user may repeatedly pull handle 110 to effect rotation of basket 104 in a single direction. This is accomplished via a suitable clutch mechanism.

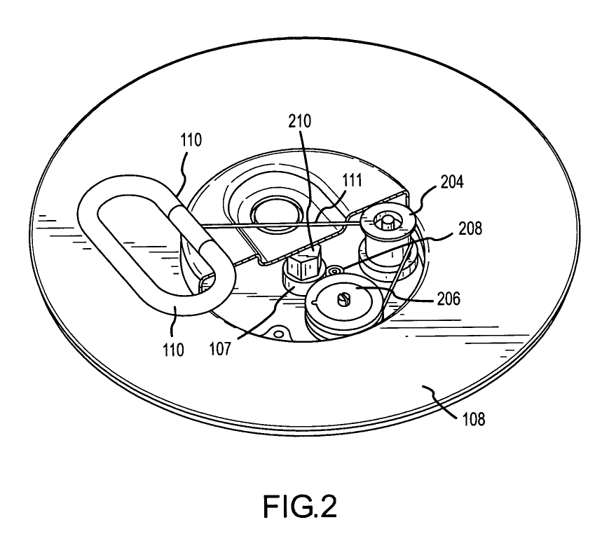

More particularly, referring to FIG. 2, one embodiment of the present invention includes a drive mechanism 112 comprising a spool 206, a pulley 204, and an idler 107. Cord 111 is connected to (and through a spring action, wraps around) spool 206. Pulley 204 acts to redirect cord 111, and may be at any number of locations depending upon a particular design, or may be dispensed with altogether. When handle 110 is pulled outward, spool 206 directly or indirectly (e.g., through various gears) causes idler 208 to engage output gear 210 which is coupled to lid portion 107 (shown on FIG. 1). A brake 202, described in further detail below, may also be incorporated into drive mechanism 112.

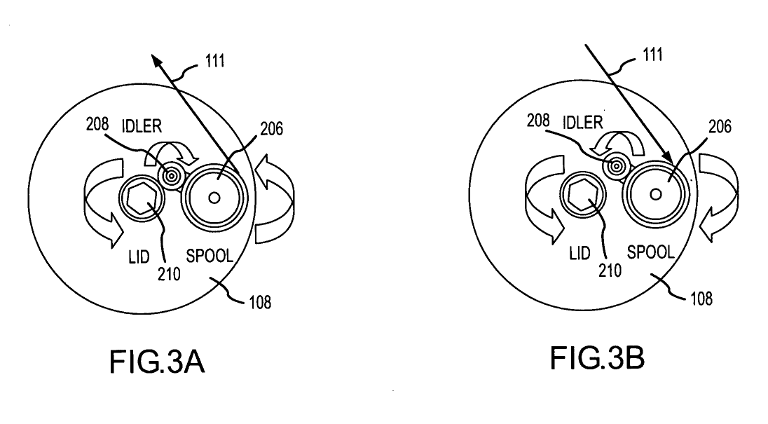

Referring to FIGS. 3A and 3B, in this embodiment, when cord 111 is pulled, spool 206 and idler 208 engage output gear 210 such that the lid and basket spin (FIG. 3A); however, when the cord 111 retracts, idler 208 disengages from output gear 210, allowing the lid and basket to spin freely.

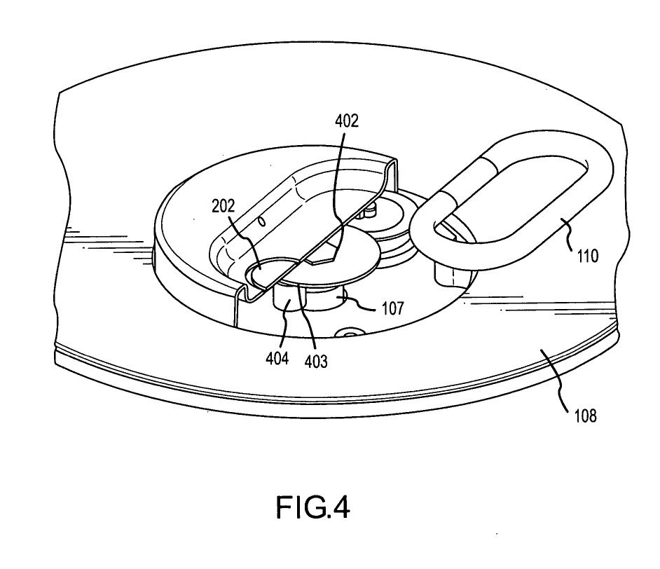

FIG. 4 shows one embodiment of a brake mechanism that may be used in connection with the present invention. As shown, a brake button 202 is included within cover 108, and is configured such that, when it is pressed downward, a brake pad 402 is squeezed between a surface of brake button 202 and a backing post 404 also coupled to lid 108. The resulting brake is effective as the brake pad 402 is squeezed between two braking surfaces (404 and 202). This design has advantages over prior art braking arrangements, which include brake devices that contact and apply frictional force to the like. That is, the present invention is advantageous in that it includes an efficient disc-break apparatus that does not contact the lid, but which slows the drive mechanism, thus indirectly stopping motion of the basket.

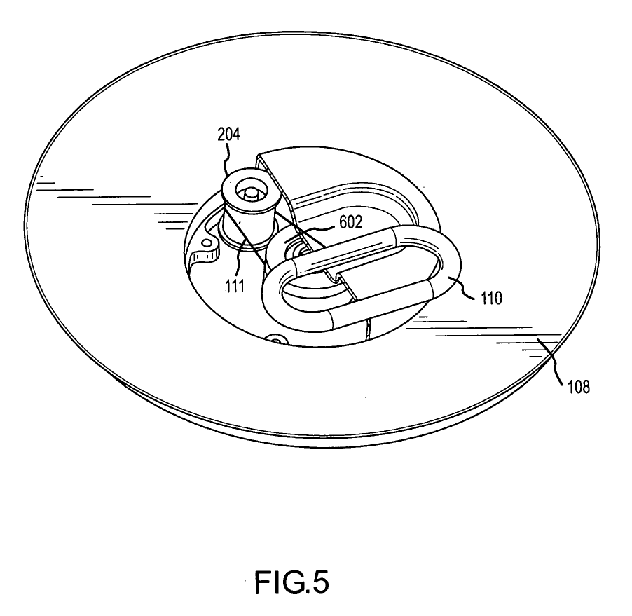

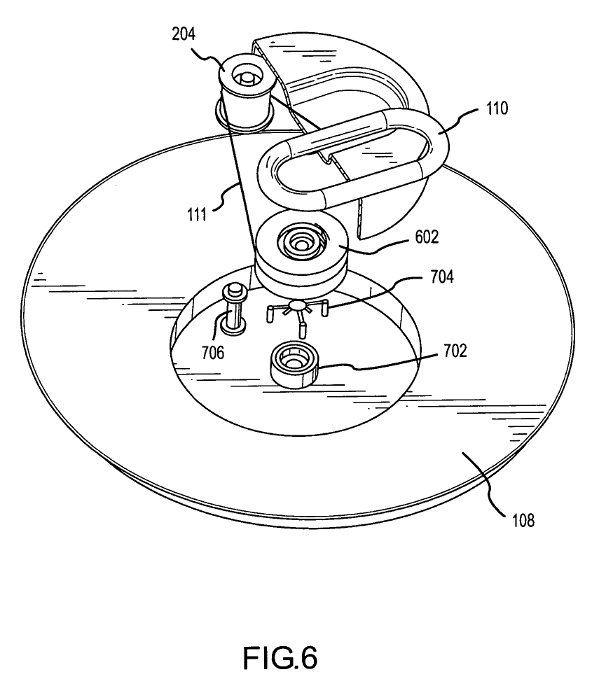

FIG. 5 shows an alternate embodiment of a drive mechanism. As shown, cord 111 (which again is coupled to handle 110) fits around pulley 204 then directly interfaces with roller clutch assembly 602, which is mechanically coupled to the lid. This is shown in further detail in FIG. 6. An axel 706 extends from cover 108 to secure pulley 204. A clutch inner race 702 (on the spinning lid) engages a clutch roller assembly (or “sprag”) 704, which in turn engages a clutch outer race within assembly 602.

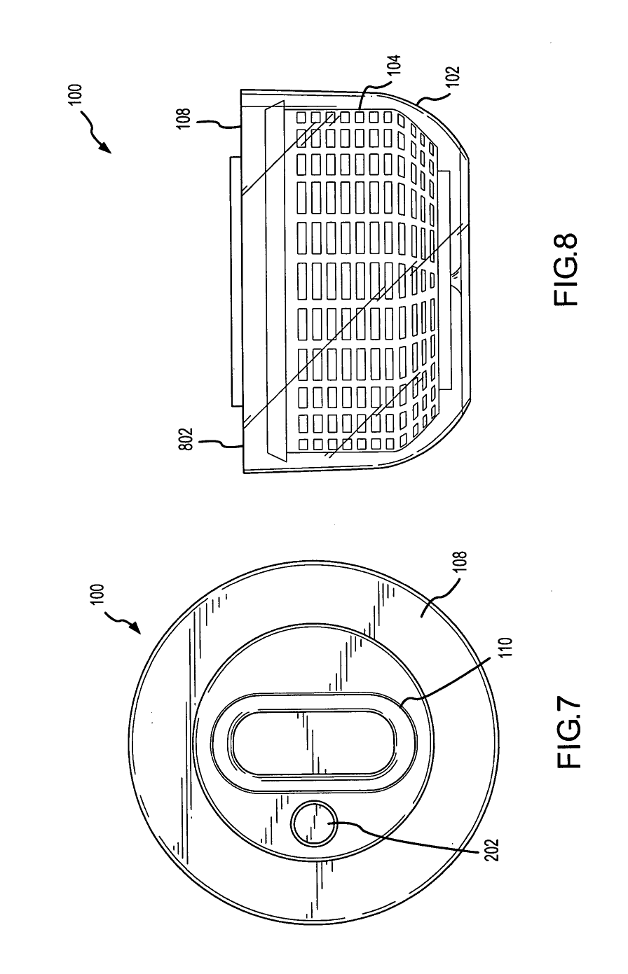

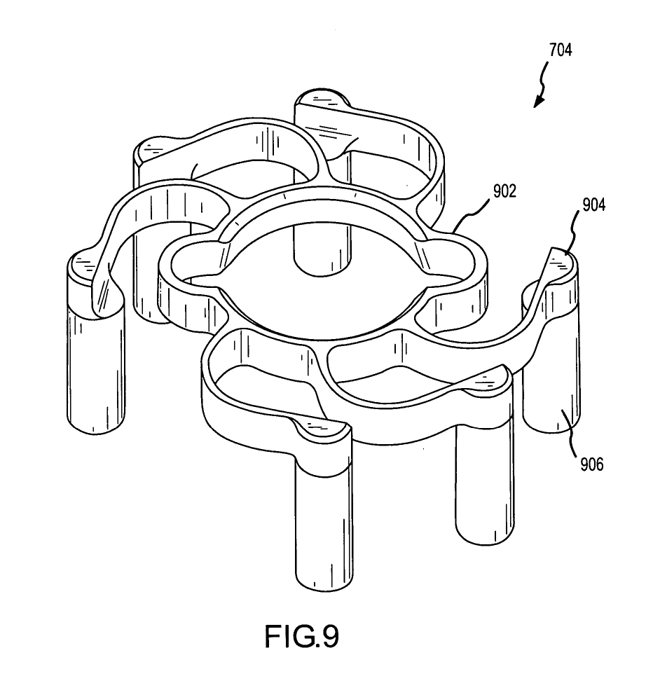

FIGS. 7 and 8 show top and side views respectively of a closed drying device 100 in accordance with one embodiment of the present invention. As shown handle 110 and the cord preferably retract into cover assembly 108, providing a substantially flat or planar top surface 802, allowing stacking of items above unit 100.

FIG. 9 depicts an alternate sprag design (see, e.g., FIG. 6, item 704). The sprag design shown in FIG. 9 includes a plurality (e.g., six) of generally radial, curved, elastically deformable members 904 extending from a central ring-like structure 902. Cylindrical portions 906 are configured to engage a clutch mechanism as sprag 704 rotates and members 904 are forced outward. It will be appreciated that many other sprag and clutch designs may be used in connection with the present invention.

In accordance with other aspects of the present invention, the basket 104 is configured such that it is perforated, but does not include thick ribs, and is therefore easier to clean.

The various embodiments of drive mechanisms described herein are in no way meant to limit the range of possible mechanical systems that might be used to effect the desired spinning of basket 104 when handle 110 is pulled outward. That is, the present invention encompasses any combination of gears, cams, pulleys, clutches, or other mechanical components that achieve the desired mechanical characteristics as described in detail above.

Other advantages and structural details of the invention will be apparent from the attached figures, which will be well understood by those skilled in the art. The present invention has been described above with to a particular exemplary embodiment. However, many changes, combinations and modifications may be made to the exemplary embodiments without departing from the scope of the present invention.

1. A vegetable drying device comprising:
An outer bowl;
An inner basket configured to fit within, and rotate with respect to, said outer bowl;
A lid removeably attached to said inner basket;
A cover assembly removeably attached to said outer bowl, said cover assembly including a handle, a drive mechanism, and a cord connecting said drive mechanism to said handle, wherein said drive mechanism is mechanically coupled to said lid when said cover assembly is attached to said outer bowl, and wherein said drive mechanism imparts rotational energy to said lid and said basket in a first direction when said handle is pulled away from said cover assembly, and wherein said basket and said lid freely rotate in said first direction when said handle is retracted.

2. The vegetable drying device of claim 1, wherein said drive mechanism further includes a braking device configured to discontinue said rotation of said inner basket.

3. The vegetable drying device of claim 2, wherein said braking device includes a brake pad mechanically coupled to said drive mechanism, a backing post, and button actuatable by a user to squeeze said brake pad between said button and said backing post.

4. The vegetable drying device of claim 1, wherein said drive mechanism includes an input gear coupled to an idler, and wherein said idler is mechanically coupled to said lid when said handle is pulled way from said cover assembly, and decoupled from said lid when said handle is retracted.

5. The vegetable drying device of claim 1, wherein said drive mechanism includes a spool connected to said cord, a clutch outer race, a clutch inner race coupled to said lid, and a clutch roller assembly provided and mechanically coupled to said inner race and said outer race.

6. The vegetable drying device of claim 1, wherein said lid is substantially transparent.

7. The vegetable drying device of claim 1, wherein said bowl is substantially transparent.

8. The vegetable drying device of claim 1, wherein said inner basket includes a plurality of perforations.

9. The vegetable drying device of claim 1, wherein said outer bowl includes an inner protrusion, and wherein said inner basket includes an indentation configured to accept said protrusion.

10. The vegetable drying device of claim 1, wherein said handle is configured to be retractable into said cover assembly such that said cover assembly is substantially flat.

11. A vegetable drying device comprising:
an outer bowl;
a perforated inner basket configured to fit within, and rotate with respect to, said outer bowl;
a substantially transparent lid removeably attached to said inner basket;
a cover assembly removeably attached to said outer bowl, said cover assembly including a retractable handle, a drive mechanism, and a cord connecting said drive mechanism to said handle, wherein said drive mechanism is mechanically coupled to said lid when said cover assembly is attached to said outer bowl, and wherein said drive mechanism imparts rotational energy to said lid and said basket in a first direction when said handle is pulled away from said cover assembly, and wherein said basket and said lid freely rotate in said first direction when said handle is retracted; and
a brakeing device comprising a brake pad mechanically coupled to said lid, a backing post, and button actuatable by a user to squeeze said brake pad between said button and said backing post;
said drive mechanism including a spool connected to said cord, a clutch outer race, a clutch inner race coupled to said lid, and a clutch roller assembly provided and mechanically coupled to said inner race and said outer race.
